(19) United States
(12) Patent Application Publication
(10) Pub. No.: US 2023/0229662 A1
(43) Pub. Date: Jul. 20, 2023

(54) INFORMATION PROCESSING SYSTEM AND LINEAGE MANAGEMENT METHOD

(71) Applicant: Hitachi, Ltd., Tokyo (JP)

(72) Inventors: Hiroaki MASUDA, Tokyo (JP); Toshihiko KASHIYAMA, Tokyo (JP); Mika TAKATA, Tokyo (JP)

(21) Appl. No.: 17/950,991

(22) Filed: Sep. 22, 2022

(30) Foreign Application Priority Data
Jan. 14, 2022 (JP) 2022-004668

(51) Int. Cl. G06F 16/2455; G06F 16/22

(52) U.S. Cl. CPC G06F 16/24564; G06F 16/2282

(57) ABSTRACT

Provided is an information processing system by which more appropriate lineage management is possible. A lineage unit management system 3 determines a lineage unit based on a processing content of data processing for generating output data including one or more elements from input data including one or more elements. A lineage management system 4 generates lineage information indicating correspondence relation between the elements of the input data and the elements of the output data in accordance with the lineage unit. Therefore, the lineage information is generated in accordance with the lineage unit corresponding to the content of the data processing, so that more appropriate lineage management is possible.

### TECHNICAL FIELD

The present disclosure relates to an information processing system and a lineage management method.

### BACKGROUND ART

In recent years, machine learning models have attracted attention, and particularly in sites of medical care, nursing care, etc., a machine learning model having high reliability is required. In order to ensure the reliability of the machine learning model, it is necessary to construct the machine learning model using appropriate learning data. The learning data is generated by processing or the like of data acquired at the site or the like, and therefore, in order to determine whether the learning data is appropriate, lineage management that manages lineage information is necessary. By the lineage information, transition of data up to the learning data can be tracked.

PTLs 1 and 2 disclose a technique for implementing the lineage management. In the technique described in PTLs 1 and 2, by analyzing a query requesting data processing, correspondence relation between input data and output data for the data processing corresponding to the query is specified, and the lineage information is generated based on the correspondence relation.

### CITATION LIST

### Patent Literature

PTL 1: US Patent Application Publication 2020/0210427 specification

PTL 2: US Patent Application Publication 2017/0270022 specification

### SUMMARY OF INVENTION

### Technical Problem

However, in the technique described in PTLs 1 and 2, correspondence relation between each element of input data and each element of output data is specified in a table unit or a column unit, and therefore, detailed lineage information cannot be obtained, and sufficient lineage management may not be executed. For example, in data processing, when input data having a vertically held structure is converted into output data having a horizontally held structure, correspondence relation between a column of the input data and a column of the output data is one to many, and therefore, by lineage information obtained in a column unit, it is difficult to track the element of the input data from the element of the output data.

An object of the present disclosure is to provide an information processing system and a lineage management method that are capable of more appropriate lineage management.

### Solution to Problem

An information processing system according to an aspect of the present disclosure is a lineage management system configured for generating lineage information indicating correspondence relation between each element, of input data including one or more elements and each element of output data including one or more elements that is generated from the input data. The information processing system includes: a rule management unit configured to determine, based on a processing content of data processing for generating the output data from the input data, a lineage unit that is a unit for defining the correspondence relation; and

a lineage management unit configured to generate the lineage information in accordance with the lineage unit.

### Advantageous Effects of Invention

According to the present invention, more appropriate lineage management is possible.

### BRIEF DESCRIPTION OF DRAWINGS

FIG. 1 is a diagram showing a configuration of an information processing system according to an embodiment of the present disclosure.

FIG. 2 is a diagram showing an example of a hardware configuration of a data management system.

FIG. 3 is a diagram showing an example of a functional configuration of the data management system.

FIG. 4 is a diagram showing an example of a functional configuration of a data analysis system.

FIG. 5 is a diagram showing an example of a functional configuration of a lineage unit management system.

FIG. 6 is a diagram showing an example of a functional configuration of a lineage management system.

FIG. 7 is a diagram showing an example of input data.

FIG. 8 is a diagram showing an example of output data.

FIG. 9 is a diagram showing an example of an execution log of data processing.

FIG. 10 is a diagram showing an example of a lineage unit determination condition table.

FIG. 11 is a diagram showing an example of a lineage unit determination table.

FIG. 12 is a diagram showing an example of a column unit lineage table.

FIG. 13 is a diagram showing an example of a conditional expression unit lineage table.

FIG. 14 is a diagram showing an example of a cell unit lineage table.

FIG. 15 is a flowchart illustrating an example of operations of an information system.

FIG. 16 is a flowchart illustrating an example of lineage unit estimated value calculation processing.

FIG. 17 is a diagram showing an example of a main screen.

FIG. 18 is a diagram showing an example of a lineage unit determination condition setting screen.

FIG. 19 is a diagram showing an example of a lineage display content input screen.

FIG. 20 is a diagram showing an example of a data lineage display screen.

FIG. 21 is a flowchart illustrating another example of the lineage unit estimated value calculation processing.

### DESCRIPTION OF EMBODIMENTS

Hereinafter, embodiments of the present disclosure will be described with reference to the drawings.

### First Embodiment

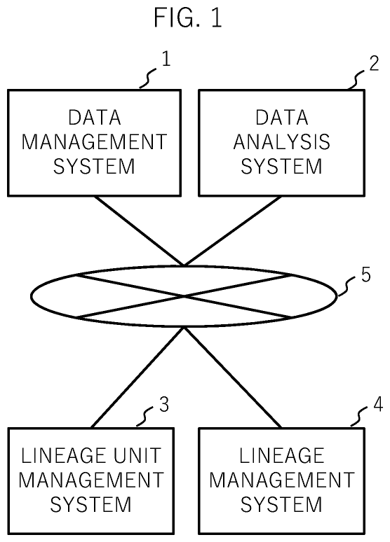

FIG. 1 is a diagram showing a configuration of an information processing system according to a first embodiment of the present disclosure. The information processing system shown in FIG. 1 includes a data management system 1, a data analysis system 2, a lineage unit management system 3, and a lineage management system 4. The data management system 1, the data analysis system 2, the lineage unit management system 3, and the lineage management system 4 are communicably connected with one another via a network 5. At least one of the data management system 1, the data analysis system 2, the lineage unit management system 3, and the lineage management system 4 may be communicably connected to, via the network 5, a terminal (not shown) used by a user who uses the information processing system.

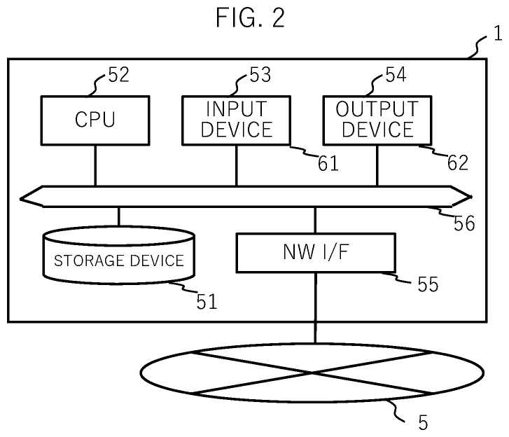

FIG. 2 is a diagram showing an example of a hardware configuration of the data management system 1. As illustrated in FIG. 2, the data management system 1 includes a storage device 51, a CPU 52, an input device 53, an output device 54, and a network interface (NW I/F) 55, which are connected with one another via a bus line 56.

The storage device 51 includes a main storage device (not illustrated) such as a memory, and an auxiliary storage device (not illustrated) such as a hard disk drive (HDD) and a solid state drive (SSD). The storage device 51 stores a program for defining an operation of the CPU 52, and various kinds of information to be used and generated by the CPU 52. The CPU 52 is a processor that reads a program stored in the storage device 51 and executes various processing by executing the read program.

The input device 53 is a device into which various kinds of information are input by the user, and the output device 54 is a device that outputs (for example, displays) various kinds of information to the user. The network interface 55 is a device that is communicably connected to, via the network 5, the data management system 1, the data analysis system 2, the lineage management system 4, and an external device such as the terminal.

Hardware configurations of the data management system 1, the data analysis system 2, and the lineage management system 4 are the same as a hardware configuration of the lineage unit management system 3 illustrated in FIG. 2. Therefore, a description thereof is omitted.

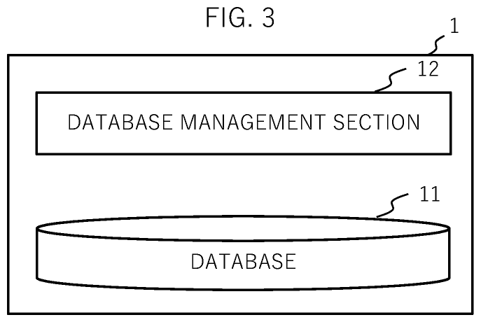

FIG. 3 is a diagram showing an example of a functional configuration of the data management system 1. The data management system 1 shown in FIG. 3 is a processing unit that executes data processing, and includes a database 11 and a database management section 12.

The database 11 is a storage unit that stores data to be used and generated in the data processing. The data is data including one or more elements, and in the present embodiment, is table data having a table structure. In this case, an element of the data is stored in a cell of a table respectively.

The database management section 12 manages the data stored in the database 11. For example, the database management section 12 executes data processing corresponding to a query that is a data processing request from the user. Specifically, the database management section 12 reads the data from the database 11 in accordance with the query, executes the data processing on input data that is the read data, and stores output data, that is data generated by the data processing, in the database 11. In the present embodiment, the query is described in an SQL statement.

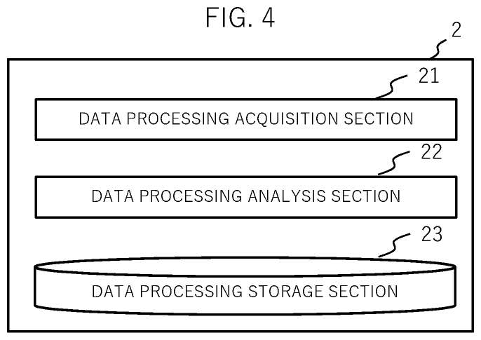

FIG. 4 is a diagram showing an example of a functional configuration of the data analysis system 2. The data analysis system 2 shown in FIG. 4 is an analysis section that analyzes the data processing, and includes a data processing acquisition section 21, a data processing analysis section 22, and a data processing storage section 23.

The data processing acquisition section 21 acquires an execution log and the query of the data processing executed by the database management section 12 of the data management system 1.

The data processing analysis section 22 analyzes the execution log that is log information of the data processing acquired by the data processing acquisition section 21, and generates data processing information indicating a content of the data processing.

The data processing storage section 23 stores the data processing information generated by the data processing analysis section 22.

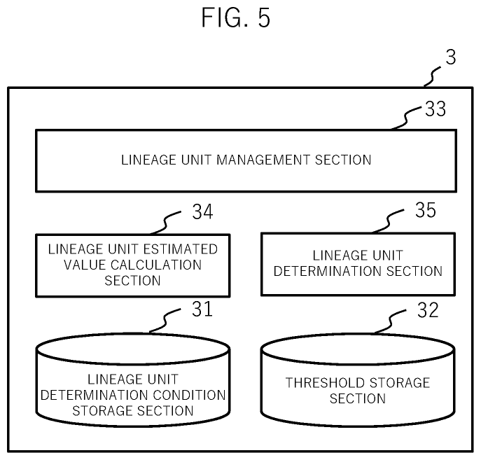

FIG. 5 is a diagram showing an example of a functional configuration of the lineage unit management system 3. The lineage unit management system 3 shown in FIG. 5 is a rule management unit that determines a lineage unit, and the lineage unit is a lineage rule for defining a correspondence relation between elements of the input data and elements of the output data for the data processing. The lineage unit management system 3 includes a lineage unit determination condition storage section 31, a threshold storage section 32, a lineage unit management section 33, a lineage unit estimated value calculation section 34, and a lineage unit determination section 35.

The lineage unit determination condition storage section 31 stores a lineage unit determination condition table showing a lineage unit determination condition that is a determination condition for determining the lineage unit. In the present embodiment, there are a plurality of lineage unit determination conditions. The threshold storage section 32 stores a lineage unit determination table that is a threshold table showing a determination threshold. The determination threshold is a threshold for determining the lineage unit. There may be a plurality of determination thresholds.

Based on an instruction from the user, the lineage unit management section 33 sets the lineage unit determination condition table and the lineage unit determination table in the lineage unit determination condition storage section 31 and the threshold storage section 32.

Based on the data processing information stored in the data processing storage section 23 of the data analysis system 2 and the lineage unit determination condition table stored in the lineage unit determination condition storage section 31, the lineage unit estimated value calculation section 34 calculates a lineage unit estimated value that is an estimated value for determining a lineage unit of target data (the input data and the output data) in the data processing. The lineage unit estimated value is, for example, a value corresponding to the correspondence relation between the element of the input data and the element of the output data for the data processing. Specifically, the lineage unit estimated value calculation section 34 determines, based on the data processing information, whether the target data corresponds to the lineage unit determination condition shown in the lineage unit determination condition table, and calculates the lineage unit estimated value based on the determination result.

The lineage unit determination section 35 compares the lineage unit estimated value calculated by the lineage unit estimated value calculation section 34 with the determination threshold shown in the lineage unit determination table stored in the threshold storage section 32, and determines the lineage unit of the target data based on a comparison result.

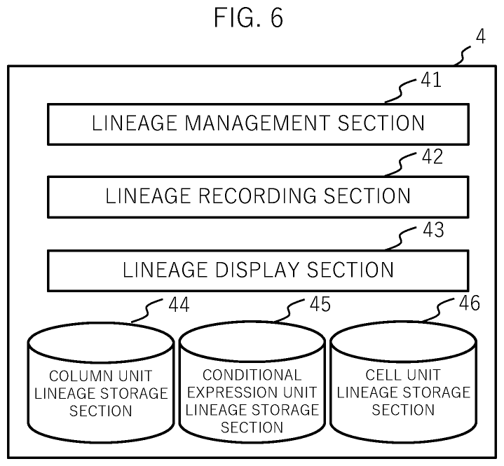

FIG. 6 is a diagram showing an example of a functional configuration of the lineage management system 4. The lineage management system 4 shown in FIG. 6 is a lineage management unit that generates lineage information indicating correspondence relation between elements of the target data, and includes a lineage management section 41, a lineage recording section 42, a lineage display section 43, a column unit lineage storage section 44, a conditional expression unit lineage storage section 45, and a cell unit lineage storage section 46.

The lineage management section 41 generates the lineage information of the target data based on the lineage unit determined by the lineage unit determination section 35.

The lineage recording section 42 records the lineage information generated by the lineage management section 41 in a storage unit corresponding to the lineage unit of the lineage information. In the present embodiment, the lineage unit includes a “column unit” that is a rule for defining the correspondence relation between elements of the target data in a column unit, a “conditional expression unit” that is a rule for defining the correspondence relation between the elements of the target data in a conditional expression unit related to a cell, and a “cell unit” that is a rule for defining the correspondence relation between the elements of the target data in a cell unit. The lineage recording section 42 stores the lineage information of the column unit in the column unit lineage storage section 44, stores the lineage information of the conditional expression unit in the conditional expression unit lineage storage section 45, and stores the lineage information of the cell unit in the cell unit lineage storage section 46.

The lineage display section 43 displays various kinds of information. For example, the lineage display section 43 displays the lineage information stored in the column unit lineage storage section 44, the conditional expression unit lineage storage section 45, and the cell unit lineage storage section 46. A display destination of the information is not particularly limited, and may be an output device such as the lineage management system 4, a display screen of the terminal used by the user, or the like.

Each of functional sections shown in FIGS. 3 to 6 is implemented by, for example, the CPU 52 shown in FIG. 2 reading the program stored in the storage device 51 and executing the read program.

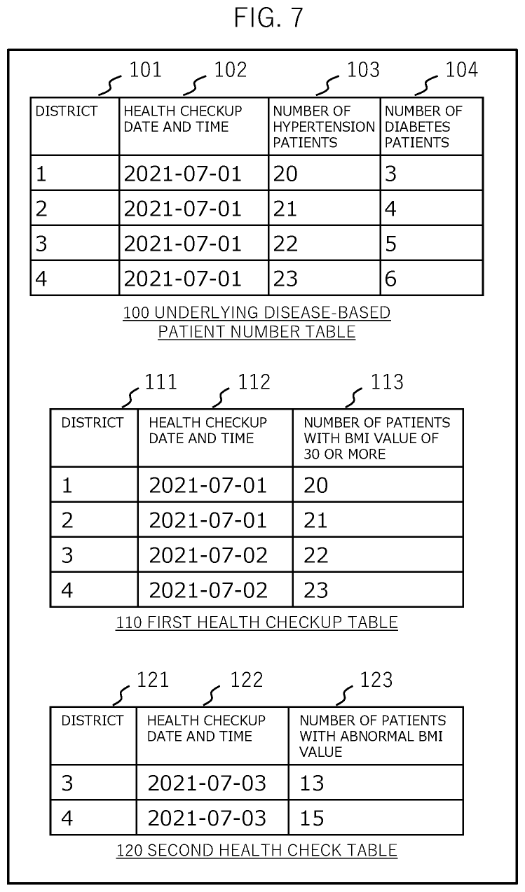

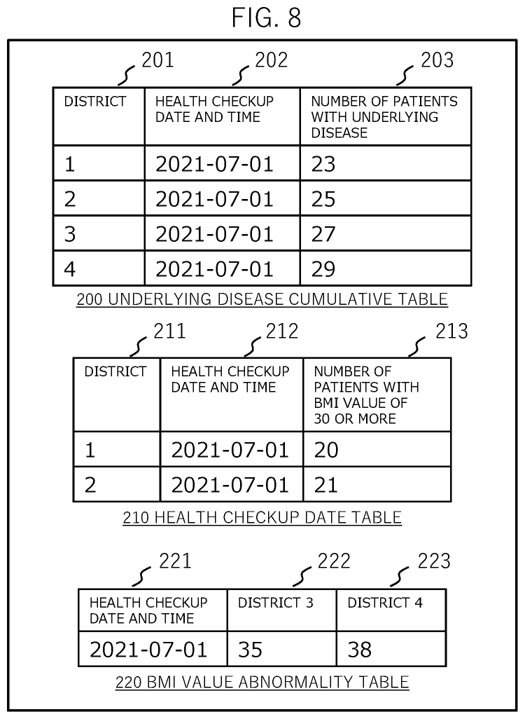

FIGS. 7 and 8 are diagrams showing examples of the data recorded in the database 11 of the data management system 1. In FIGS. 7 and 8, data related to a health check, particularly, data related to a body mass index (BMI) value is illustrated as the data, and the type of the data is not particularly limited.

In the examples of FIGS. 7 and 8, the database 11 includes, as the data, an underlying disease-based patient number table 100, a first health checkup table 110, and a second health checkup table 120 shown in FIG. 7, and an underlying disease cumulative table 200, a health checkup date table 210, and a BMI value abnormality table 220 shown in FIG. 8.

The underlying disease-based patient number table 100 includes a column 101 for storing a district number for identifying a district where the health checkup is performed, a column 102 for storing a health checkup date and time that is the date and time when the health checkup is performed, a column 103 for storing the number of hypertension patients which is the number of patients determined as hypertension, and a column 104 for storing the number of diabetes patients which is the number of patients determined as diabetes.

The first health checkup table 110 includes a column 111 for storing a district number, a column 112 for storing a health checkup date and time, and a column 113 for storing the number of patients with a BMI value of 30 or more, which is the number of patients whose BMI value is 30 or more.

The second health checkup table 120 includes a column 121 for storing a district number, a column 122 for storing a health checkup date and time, and a column 123 for storing the number of patients with abnormal BMI value that is the number of patients whose BMI value is determined to be abnormal.

The underlying disease cumulative table 200 includes a column 201 for storing a district number, a column 202 for storing a health checkup date and time, and a column 203 for storing the number of patients with underlying disease, which is the number of patients who have an underlying disease.

The health checkup date table 210 includes a column 211 for storing a district number, a column 212 for storing a health checkup date and time, and a column 212 for storing the number of patients with the BMI value of 30 or more.

The BMI value abnormality table 220 includes a column 221 for storing a health checkup date and time, a column 222 for storing the number of patients with abnormal BMI value in a district 3 (a district having a district number “3”), and a column 223 for storing the number of patients with abnormal BMI value in a district 4 (a district having a district number “4”).

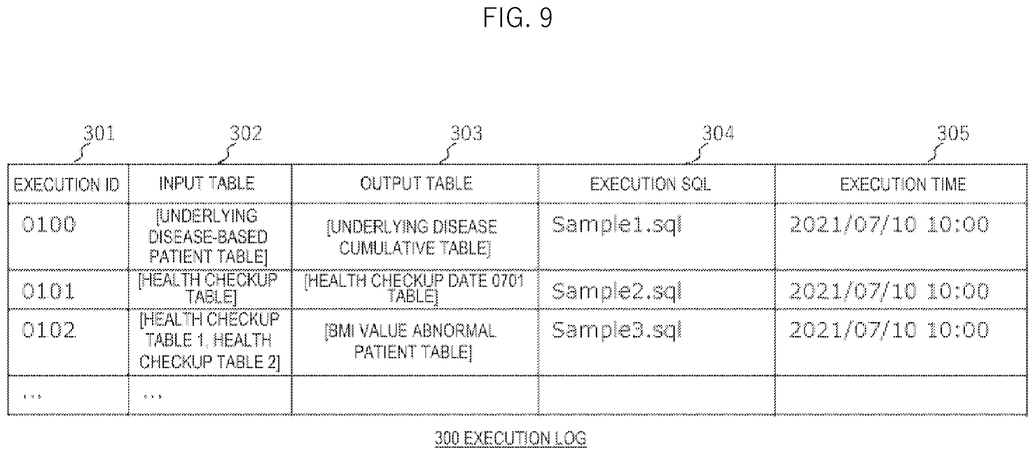

FIG. 9 is a diagram showing an example of an execution log of the data processing. An execution log 300 shown in FIG. 9 includes columns 301 to 305. The column 301 stores an execution ID for identifying the executed data processing. The column 302 stores an input table name for identifying an input table that is the input data used in the data processing. The column 303 stores an output table name for identifying an output table that is the output data generated in the data processing. The column 304 stores execution SQL information indicating a query requesting the executed data processing. The column 305 stores an execution time that is the date and time when the data processing is executed.

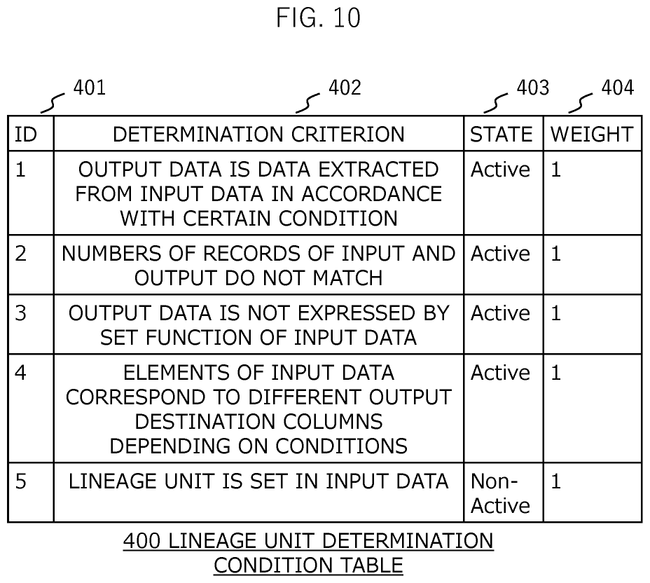

FIG. 10 is a diagram showing an example of the lineage unit determination condition table. A lineage unit determination condition table 400 shown in FIG. 10 includes columns 401 to 404.

The column 401 stores a condition ID for identifying the lineage unit determination condition. The column 402 stores determination criteria that are the lineage unit determination condition. The column 403 stores state information indicating whether a determination criterion is used for the determination of the lineage unit. The column 404 stores a weight value that is a numerical value allocated to the determination criterion.

In the present embodiment, the determination criteria include “the output data is data extracted from the input data in accordance with a specific condition”, “the number of records of input and output (the numbers of records of the input data and the output data) do not match”, “the output data is not expressed by a set function of the input data (including a combination of a plurality of set functions)”, “elements of the input data correspond to different output destination columns depending on the conditions”, and “the lineage unit is set in the input data”. The set function is a function (SUM, MAX, or the like) provided in the SQL. The output data for certain data processing may be the input data for another data processing, and in this case, the lineage unit is already set in the input data for the another data processing.

The state information shows “Active” when the determination criterion is used for the determination of the lineage unit, and shows “Non-Active” when the determination criterion is not used for the determination of the lineage unit. In the example of FIG. 10, the weights are all the same, but may be different values.

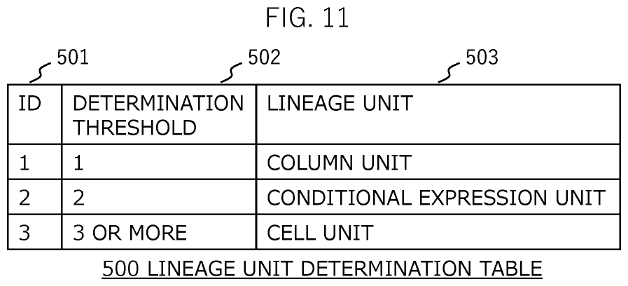

FIG. 11 is a diagram showing an example of the lineage unit determination table. The lineage unit determination table shown in FIG. 11 includes columns 501 to 503.

The column 501 stores a threshold ID for identifying a determination threshold. The column 502 stores the determination threshold. The column 502 stores a lineage unit corresponding to the determination threshold.

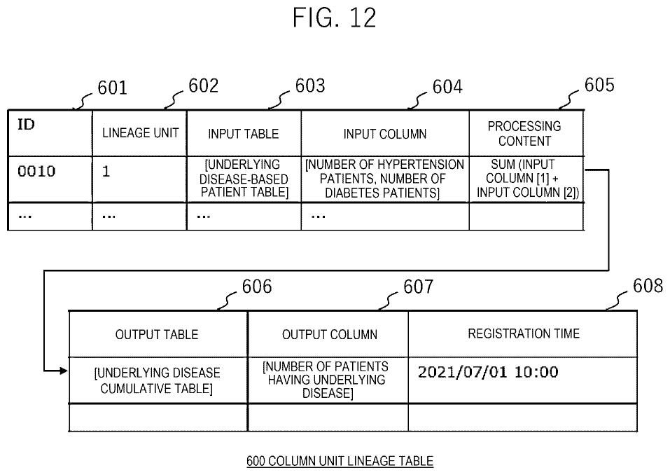

FIGS. 12 to 14 are diagrams showing examples of the lineage information.

FIG. 12 is a diagram showing an example of a column unit lineage table that is the lineage information in the column unit. A column unit lineage table 600 shown in FIG. 12 includes columns 601 to 608.

The column 601 stores a lineage ID for identifying the lineage information. The column 602 stores a lineage unit. In FIGS. 12 to 14, as the lineage units, the column unit is indicated by “1”, the conditional expression unit is indicated by “2”, and the cell unit is indicated by “3”. The column 603 stores an input table name for identifying the input data. The column 604 stores an input column name for identifying a column having the correspondence relation with the output data in the input data. The column 605 stores a processing content of the data processing. The column 606 stores an output table name for identifying the output data. The column 607 stores an output column name for identifying an output column having the correspondence relation with the column of the input column name in the output data. The column 608 stores a registration time that is a date and time when the lineage information is registered.

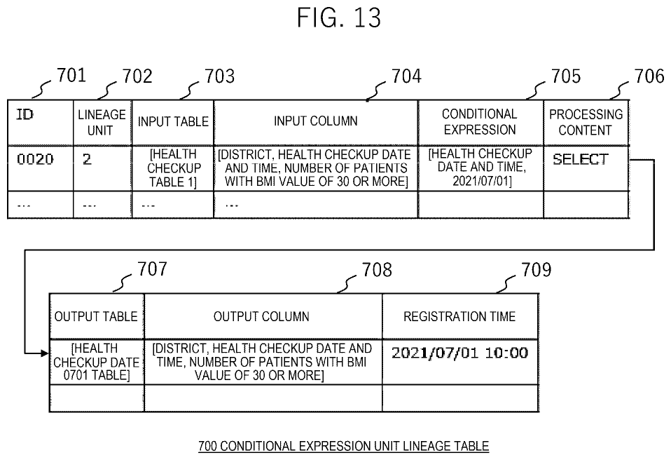

FIG. 13 is a diagram showing an example of a conditional expression unit lineage table that is the lineage information in the conditional expression unit. A conditional expression unit lineage table 700 shown in FIG. 13 includes columns 701 to 709.

The column 701 stores a lineage ID for identifying the lineage information. The column 702 stores a lineage unit. The column 703 stores an input table name. The column 704 stores an input column name. The column 705 stores a conditional expression. The column 706 stores a processing content in the data processing. The column 707 stores an output table name. The column 708 stores an output column name for identifying an output column. The column 709 stores a registration time.

The conditional expression stored in the column 705 is a condition related to a cell included in the column of the input column name, and for example, in the example of FIG. 13, the conditional expression is a condition for associating a cell in which a value of the health checkup date and time is “2021/07/01”.

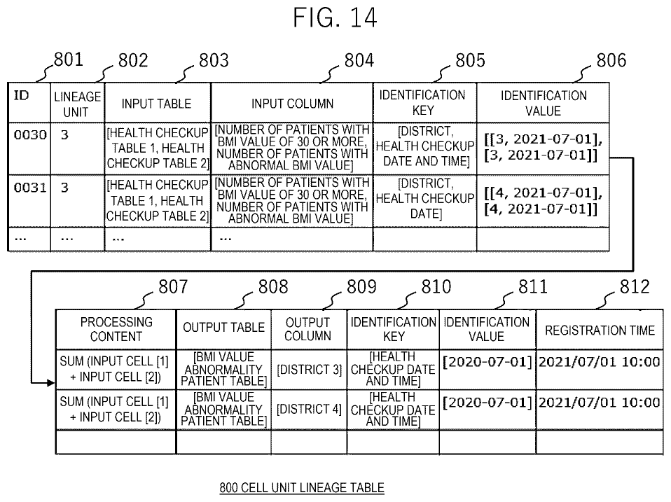

FIG. 14 is a diagram showing an example of a cell unit lineage table that is the lineage information of the cell unit. A cell unit lineage table 800 shown in FIG. 14 includes columns 801 to 812.

The column 801 stores an ID for identifying the lineage. The column 802 stores a lineage unit. The column 803 stores an input table name. The column 804 stores an input column name. The column 805 stores an input identification key for identifying a cell having the correspondence relation with a cell of the output data in the input data, and the column 806 stores an input identification value that is a value of the input identification key.

The column 807 stores a processing content of the data processing. The column 808 stores an output table name. The column 809 stores an output column name. The column 810 store an output identification key for identifying the cell having the correspondence relation with the cell of the input data in the output data, and the column 811 stores an output identification value that is a value of the output identification key. The column 812 stores a registration time.

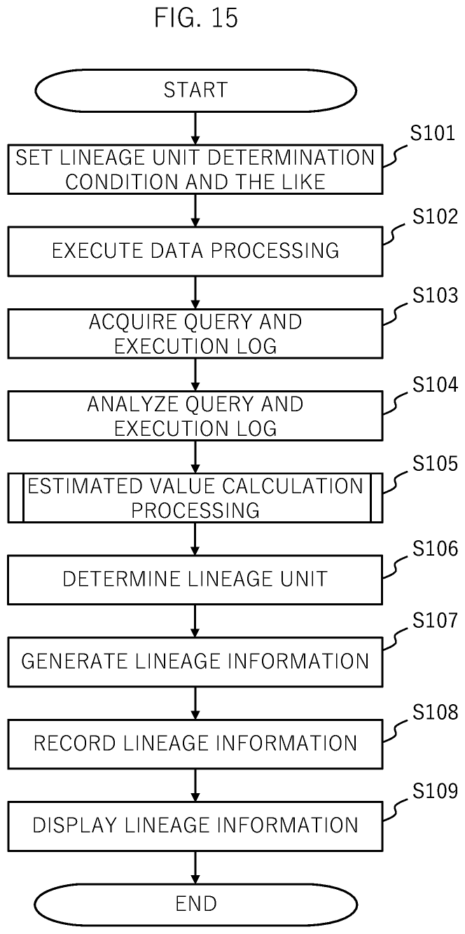

FIG. 15 is a flowchart illustrating an example of operations of an information system in the embodiment.

First, the lineage management system 4 sets the lineage unit determination condition and the determination threshold in the lineage unit determination condition storage section 31 and the threshold storage section 32 of the lineage unit management system 3, respectively (step S101).

Thereafter, when receiving the query from the terminal of the user or the like, the database management section 12 of the data management system 1 reads the data from the database 11 in accordance with the query, executes the data processing on input data that is the read data, and stores the output data, that is the data generated by the data processing, in the database 11. At this time, the database management section 12 generates the execution log of the data processing and stores the execution log in the database 11 (step S102).

The data processing acquisition section 21 of the data analysis system 2 detects execution of the data processing executed by the data management system 1, and acquires an execution log corresponding to this data processing (step S103).

The data processing analysis section 22 analyzes the execution log acquired by the data processing acquisition section 21, generates the data processing information indicating the content of the data processing, and stores the data processing information in the data processing storage section 23 (step S104).

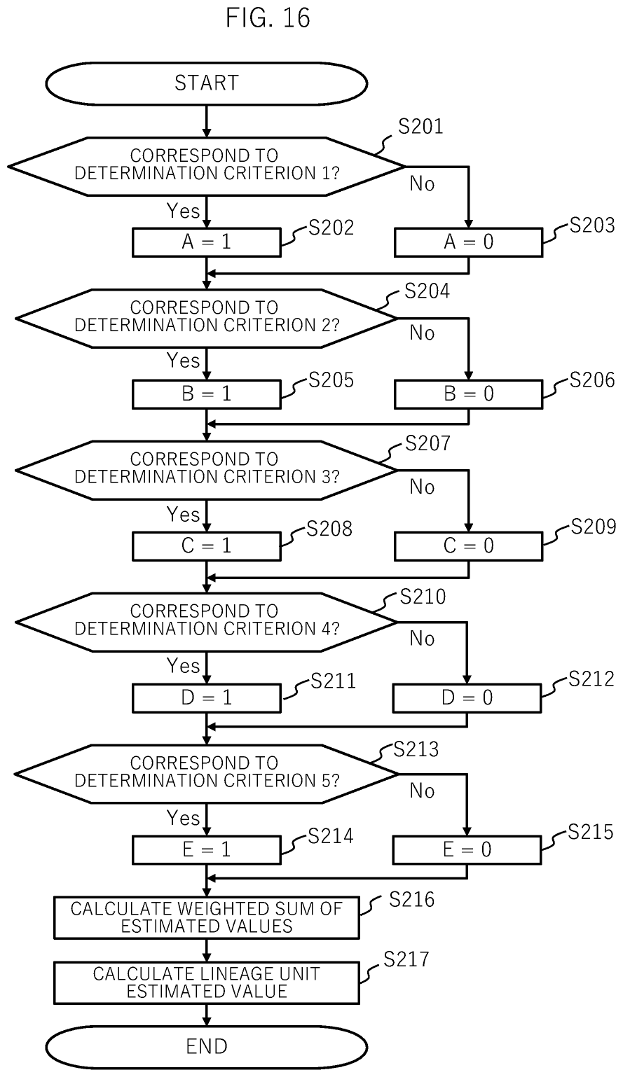

Thereafter, based on the data processing information stored in the data processing storage section 23 and the lineage unit determination condition table stored in the lineage unit determination condition storage section 31, the lineage unit estimated value calculation section 34 of the lineage unit management system 3 executes estimated value calculation processing (see FIG. 16) for calculating the lineage unit estimated value (step S105).

Based on the lineage unit estimated value calculated by the lineage unit estimated value calculation section 34 and the lineage unit determination table stored in the threshold storage section 32, the lineage unit determination section 35 determines the lineage unit of the target data (step S106). Specifically, the lineage unit determination section 35 compares the lineage unit estimated value with the determination threshold in the lineage unit determination table, and determines the lineage unit of the target data based on the comparison result.

Then, the lineage management section 41 of the lineage management system 4 generates the lineage information of the target data based on the lineage unit determined by the lineage unit determination section 35 (step S107).

The lineage recording section 42 stores, depending on the lineage unit, the lineage information generated by the lineage management section 41 in any of the column unit lineage storage section 44, the conditional expression unit lineage storage section 45, and the cell unit lineage storage section 46 (step S108).

Thereafter, the lineage display section 43 displays various kinds of information. For example, the lineage display section 43 displays the lineage information stored in the column unit lineage storage section 44, the conditional expression unit lineage storage section 45, and the cell unit lineage storage section 46 (step S109), and ends the processing. The lineage display section 43 may process and display the lineage information.

FIG. 16 is a flowchart illustrating an example of the lineage unit estimated value calculation processing in step S105 of FIG. 15.

In the lineage unit estimated value calculation processing, first, the lineage unit estimated value calculation section 34 determines whether the target data corresponds to a determination criterion 1 “the output data is the data extracted from the input data in accordance with the specific condition” that is a determination criterion having an ID of “1” in FIG. 10 (step S201).

If the target data corresponds to the determination criterion 1, the lineage unit estimated value calculation section 34 sets a determination value “A” corresponding to the determination criterion 1 to 1 (step S202). On the other hand, if the target data does not correspond to the determination criterion 1, the lineage unit estimated value calculation section 34 sets the determination value “A” to 0 (step S203).

Subsequently, the lineage unit estimated value calculation section 34 determines whether the target data corresponds to a determination criterion 2 “the numbers of the records of the output do not match” that is a determination criterion having an ID of “2” in FIG. 10 (step S204).

If the target data corresponds to the determination criterion 2, the lineage unit estimated value calculation section 34 sets a determination value “B” corresponding to the determination criterion 2 to 1 (step S205). On the other hand, if the target data does not correspond to the determination criterion 2, the lineage unit estimated value calculation section 34 sets the determination value “B” to 0 (step S206).

Subsequently, the lineage unit estimated value calculation section 34 determines whether the target data corresponds to a determination criterion 3 “the output data is not expressed by the set function of the input data” that is a determination criterion having an ID of “3” in FIG. 10 (step S207).

If the target data corresponds to the determination criterion 3, the lineage unit estimated value calculation section 34 sets a determination value “C” corresponding to the determination criterion 3 to 1 (step S208). On the other hand, if the target data does not correspond to the determination criterion 3, the lineage unit estimated value calculation section 34 sets the determination value “C” to 0 (step S209).

Subsequently, the lineage unit estimated value calculation section 34 determines whether the target data corresponds to a determination criterion 4 “the elements of the input data correspond to the different output destination columns depending on the conditions” that is a determination criterion having an ID of “4” in FIG. 10 (step S210).

If the target data corresponds to the determination criterion 4, the lineage unit estimated value calculation section 34 sets a determination value “D” corresponding to the determination criterion 4 to 1 (step S211). On the other hand, if the target data does not correspond to the determination criterion 4, the lineage unit estimated value calculation section 34 sets the determination value “D” to 0 (step S212).

Subsequently, the lineage unit estimated value calculation section 34 determines whether the target data corresponds to a determination criterion 5 “the lineage unit is set in the input data” that is a determination criterion having an ID of “5” in FIG. 10 (step S213).

If the target data corresponds to the determination criterion 5, the lineage unit estimated value calculation section 34 sets a determination value “E” corresponding to the determination criterion 5 to 1 (step S214). On the other hand, if the target data does not correspond to the determination criterion 5, the lineage unit estimated value calculation section 34 sets the determination value “E” corresponding to the determination criterion 5 to 0 (step S215).

Thereafter, the lineage unit estimated value calculation section 34 calculates a weighted sum of the determination values A to E of the respective determination criteria 1 to 5 using the weight values of the determination criteria 1 to 5 illustrated in FIG. 10 (step S216). When the weight values of the determination criteria 1 to 5 are x₁ to x₅, the weighted sum Y is Y=Ax₁+bx₂+Cx₃+Dx₄+Ex₅.

The lineage unit estimated value calculation section 34 calculates the weighted sum Y as the lineage unit estimated value (step S217), and ends the lineage unit estimated value calculation processing.

For example, in a case in which the data processing is processing for adding values in the column 103 and values in the column 104 of the underlying disease-based patient number table 100 of FIG. 7 to generate the underlying disease cumulative table 200 of FIG. 8, the target data (the underlying disease-based patient number table 100 and the underlying disease cumulative table 200) corresponds to only the determination criterion 3. Therefore, the determination value C is 1, other determination values are 0, and the lineage unit estimated value is 1. In this case, when the lineage unit determination table 500 is used, the lineage unit is the column unit.

In addition, in a case in which the data processing is processing for extracting values “2021-07-01” in the column 112 of the first health checkup table 110 of FIG. 7 to generate the health checkup date table 210 of FIG. 8, the target data (the first health checkup table 110 and the health checkup date table 210) corresponds to only the determination criteria 1 and 3. Therefore, the determination values A and C are 1, other determination values are 0, and the lineage unit estimated value is 2. In this case, when the lineage unit determination table 500 is used, the lineage unit is the conditional expression unit.

In addition, in a case in which the data processing is processing for calculating a sum of the number of patients with the BMI value of 30 or more and the number of patients with abnormal BMI value in the district 3 and the district 4 in the first health checkup table 110 and the second health checkup table 120 of FIG. 7 to generate the BMI value abnormality table 220 of FIG. 8, the target data (the first health checkup table 110, the second health checkup table 120, and the BMI value abnormality table 220) corresponds to the determination criteria 1 to 4. Therefore, the determination values A to D are 1, the determination value E is 0, and the lineage unit estimated value is 4. In this case, when the lineage unit determination table 500 is used, the lineage unit is the cell unit.

It is assumed that the lineage unit is not set in the underlying disease-based patient number table 100, the first health checkup table 110, and the second health checkup table 120 shown in FIG. 7.

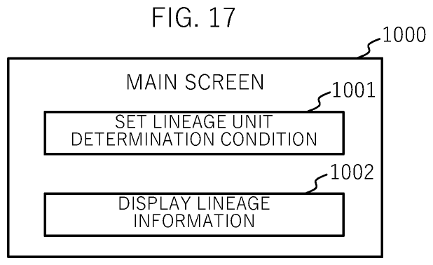

FIGS. 17 to 20 are diagrams showing examples of display screens displayed by the lineage display section 43.

FIG. 17 is a diagram showing an example of a main screen. A main screen 1000 shown in FIG. 17 is a screen displayed in the processing of steps S101, S109, and the like of FIG. 15, and includes a setting button 1001 and a display button 1002. The setting button 1001 is a button for setting the lineage unit determination condition and the determination threshold. The display button 1002 is a button for displaying the lineage information.

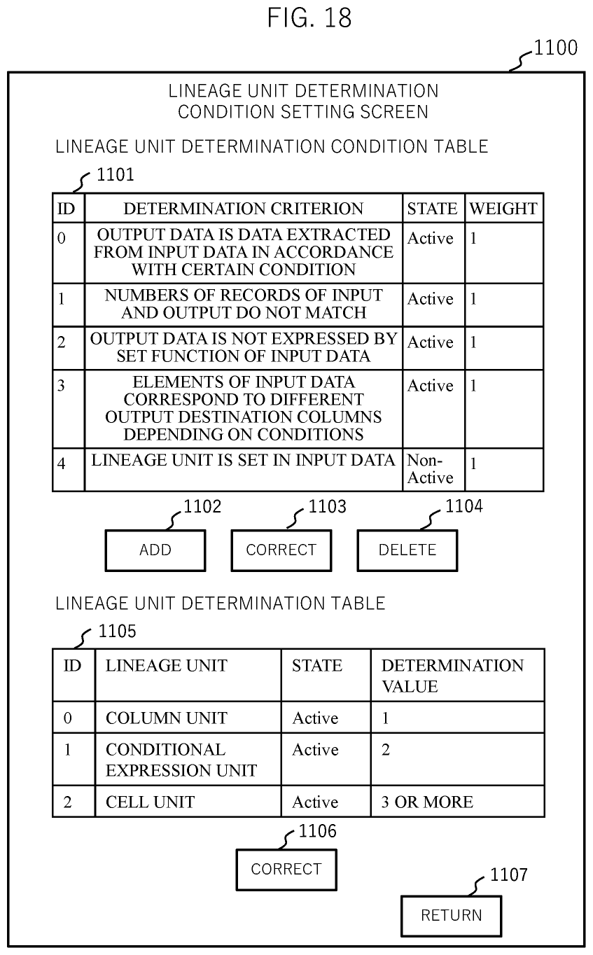

FIG. 18 is a diagram showing an example of a lineage unit determination condition setting screen. A lineage unit determination condition setting screen 1100 shown in FIG. 18 is a screen for setting the lineage unit determination condition and the determination threshold, and is displayed, for example, when the setting button 1001 of FIG. 17 is pressed.

The lineage unit determination condition setting screen 1100 includes a lineage unit determination condition table 1101, an add button 1102, a correct button 1103, a delete button 1104, a lineage unit determination table 1105, a correct button 1106, and a return button 1107.

The lineage unit determination condition table 1101 shows the contents of the currently set lineage unit determination condition table. The add button 1102 is a button for adding a determination criterion to the lineage unit determination condition table. The correct button 1103 is a button for correcting the content of the lineage unit determination condition table. The delete button 1104 is a button for deleting a determination criterion from the lineage unit determination condition table.

The lineage unit determination table 1105 shows the contents of the currently set lineage unit determination table. The correct button 1106 is a button for correcting the content of the lineage unit determination table.

The return button 1108 is a button for ending the setting of the lineage unit determination condition and the determination threshold and returning to the main screen 1000.

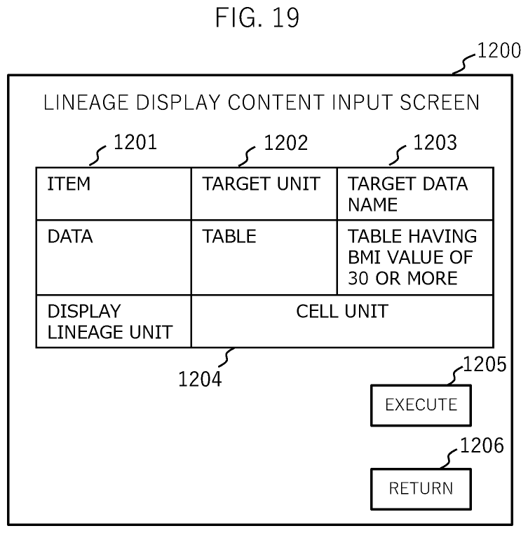

FIG. 19 is a diagram showing an example of a lineage display content input screen. A lineage display content input screen 1200 shown in FIG. 19 is a screen for setting contents of lineage information to be displayed, and is displayed, for example, when the display button 1002 shown in FIG. 17 is pressed.

The lineage display content input screen 1200 includes an item input field 1201, a target unit input field 1203, a target data name input field 1204, a display lineage unit input field 1205, an execute button 1206, and a return button 1207.

The item input field 1201 is a field for inputting an item of the lineage information to be displayed. The target unit input field 1203 is a field for inputting a unit of the lineage information to be displayed. The target data name input field 1204 is a field for inputting a name of the data (output data) of the lineage information to be displayed. The display lineage unit input field 1205 is a field for inputting a lineage unit of the data of the lineage information to be displayed.

The execute button 1206 is a button for confirming contents input into the input fields 1201 to 1205 and displaying the lineage information. The return button 1207 is a button for stopping the display of the lineage information and returning to the main screen 1000.

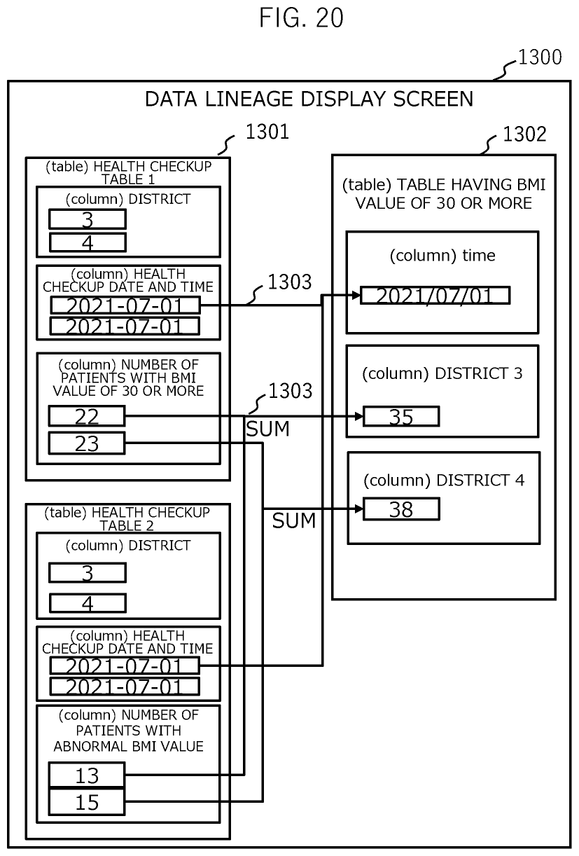

FIG. 20 is a diagram showing an example of a data lineage display screen. A data lineage display screen 1300 shown in FIG. 20 includes input data 1301, output data 1302, and link information 1303.

The input data 1301 and the output data 1302 are data having correspondence relation with each other. The link information 1303 is information indicating the correspondence relation between the input data 1301 and the output data 1302, and in the example of FIG. 20, the link information 1303 shows relation between cells having correspondence relation with each other in the input data 1301 and the output data 1302.

As described above, according to the present embodiment, the lineage unit management system 3 determines the lineage unit based on the processing content of the data processing for generating the output data including one or more elements from the input data including one or more elements. The lineage management system 4 generates the lineage information indicating the correspondence relation between the elements of the input data and the elements of the output data in accordance with the lineage unit. Therefore, since the lineage information is generated in accordance with the lineage unit corresponding to the content of the data processing, more appropriate lineage management is possible.

Further, in the present embodiment, the lineage unit is determined based on the lineage unit estimated value and the lineage unit determination table. Specifically, the lineage unit estimated value is calculated based on the determination result as to whether the target data including the input data and the output data corresponds to the lineage unit determination condition. Therefore, since the lineage unit is determined based on an appropriate determination condition corresponding to the data processing, more appropriate lineage management is possible.

In addition, in the present embodiment, since there are a plurality of lineage unit determination conditions, the lineage unit can be more appropriately determined.

In the present embodiment, the lineage unit is determined in accordance with the lineage unit estimated value that is a sum of the weight values assigned for the lineage unit determination conditions to which the target data corresponds. Therefore, since it is possible to determine the lineage unit in consideration of the importance of the lineage unit determination condition or the like, it is possible to more appropriately determine the lineage unit.

In the present embodiment, the lineage unit includes the column unit, the cell unit, and the conditional expression unit. Therefore, it is possible to determine a lineage unit suitable for table data.

### Second Embodiment

Next, a second embodiment will be described.

The present embodiment is different from the first embodiment in the lineage unit estimated value calculation processing in step S105 of FIG. 15.

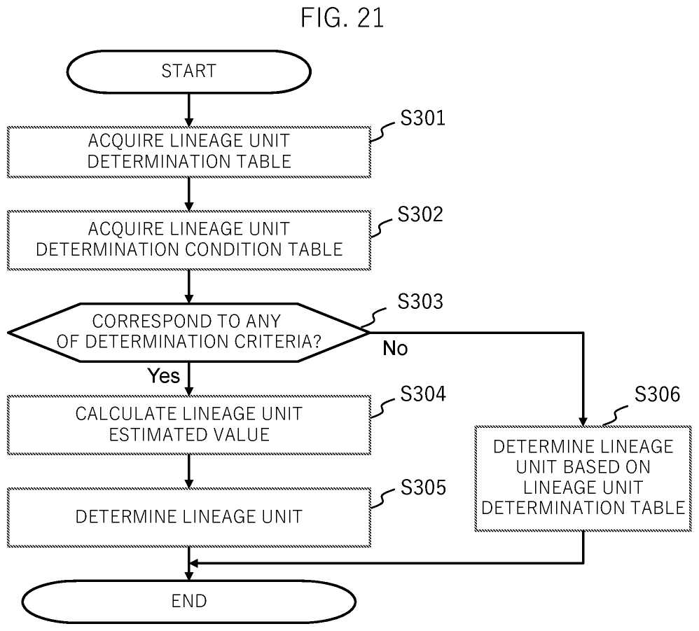

FIG. 21 is a flowchart illustrating an example of lineage unit estimated value calculation processing according to the present embodiment.

In the lineage unit estimated value calculation processing of the present embodiment, first, the lineage unit estimated value calculation section 34 acquires a lineage unit determination table from the threshold storage section 32 (step S301), and acquires a lineage unit determination condition table from the lineage unit determination condition storage section 31 (step S302).

Based on data processing information stored in the data processing storage section 23 of the data analysis system 2, the lineage unit estimated value calculation section 34 determines whether target data in data processing corresponds to any of determination criteria (lineage unit determination conditions) shown by the lineage unit determination condition table (step S303). This determination can be executed, for example, by executing the processing from step S201 to step S215 of FIG. 16.

In a case in which the target data corresponds to any of the determination criteria, the lineage unit estimated value calculation section 34 calculates, based on the lineage unit determination condition table, a sum of weight values of the corresponding determination criteria as a lineage unit estimated value (step S304). Then, the lineage unit determination section 35 compares the lineage unit estimated value and a determination threshold in the lineage unit determination table, determines a lineage unit of the target data based on the comparison result (step S305), and ends the processing.

On the other hand, in a case in which the target data does not correspond to any one of the determination criteria, the lineage unit determination section 35 determines the lineage unit of the target data based on the lineage unit determination table (step S306), and ends the processing. Specifically,

As described above, according to the present embodiment, even in the case in which the target data does not correspond to any one of the determination criteria, it is also possible to determine an appropriate lineage rule.

The embodiments of the present disclosure described above are examples for the purpose of explaining the present disclosure, and the scope of the present disclosure is not intended to be limited only to those embodiments. A person skilled in the art could have implemented the present disclosure in various other embodiments without departing from the scope of the present disclosure.

### REFERENCE SIGNS LIST

1 Data management system

2 Data analysis system

3 Lineage unit management system

4 Lineage management system

11 Database

12 Database management section

21 Data processing acquisition section

22 Data processing analysis section

23 Data processing storage section

31 Lineage unit determination condition storage section

32 Threshold storage section

33 Lineage unit management section

34 Lineage unit estimated value calculation section

35 Lineage unit determination section

41 Lineage management section

42 Lineage recording section

43 Lineage display section

44 Column unit lineage storage section

45 Conditional expression unit lineage storage section

46 Cell unit lineage storage section

1. A lineage management system for generating lineage information indicating correspondence relation between each element of input data including one or more elements and each element of output data including one or more elements that is generated from the input data, the lineage management system comprising:
a rule management unit configured to determine, based on a processing content of data processing for generating the output data from the input data, a lineage unit that is a unit for defining the correspondence relation; and
a lineage management unit configured to generate the lineage information in accordance with the lineage unit.

2. The lineage management system according to claim 1, wherein
the rule management unit is configured to calculate a lineage unit estimated value corresponding to the correspondence relation, and to determine the lineage unit based on the lineage unit estimated value and a threshold table showing relation between the lineage unit and a threshold.

3. The information processing system according to claim 2, wherein
the rule management unit is configured to determine whether target data including the input data and the output data corresponds to a determination condition related to the correspondence relation, and to calculate the lineage unit estimated value based on the determination result.

4. The information processing system according to claim 3, wherein
the rule management unit is configured to determine whether the target data corresponds to the determination condition for each of a plurality of the determination conditions, and to calculate the lineage unit estimated value based on the determination condition to which the target data corresponds.

5. The information processing system according to claim 4, wherein
the rule management unit is configured to calculate, as a lineage unit estimated value, a sum of numerical values assigned in advance to the determination conditions to which the target data corresponds.

6. The information processing system according to claim 1, wherein
the input data and the output data are table data having a table structure, and
the element is stored in each cell of the table data.

7. The information processing system according to claim 6, wherein
the lineage unit is either a column unit of the table data or a cell unit of the table data.

8. The information processing system according to claim 6, wherein
the lineage unit is any of a column unit of the table data, a cell unit of the table data, and a conditional expression unit related to cells of the table data.

9. A lineage management method executed by a lineage management system, the lineage management system including a processor, the lineage management system for generating lineage information indicating correspondence relation between each element of input data including one or more elements and each element of output data including one or more elements that is generated from the input data, the lineage management method comprising:
determining, by the processor, a lineage unit that is a unit for defining the correspondence relation based on a processing content of data processing for generating the output data from the input data; and
generating, by the processor, the lineage information in accordance with the lineage unit.
